(19) United States
(12) Patent Application Publication
(10) Pub. No.: US 2015/0327317 A1
(43) Pub. Date: Nov. 12, 2015

(54) METHOD AND APPARATUS FOR EXTENDING COVERAGE IN A MOBILE RADIO COMMUNICATION SYSTEM

(71) Applicant: MOTOROLA SOLUTIONS, INC, SCHAUBURG, IL (US)

(72) Inventors: PAWEL JURZAK, KRAKOW (PL); WALDEMAR DWORAKOWSKI, WARSZAWA (PL); DANIEL FRUZYNSKI, MIEJSCE PIASTOWE (PL); PIOTR KUZIO, KRAKOW (PL); ALEJANDRO RODRIGUEZ MARTINEZ, KRAKOW (PL); DOMINIK WOJTASZEK, DEBICA (PL)

(21) Appl. No.: 14/650,603

(22) PCT Filed: Dec. 28, 2012
(86) PCT No.: PCT/PL2012/000132

§ 371 Date: Jun. 9, 2015

(51) Int. Cl. H04W 76/02; H04W 4/22; H04W 76/00

(52) U.S. Cl. CPC H04W 76/026; H04W 76/007; H04W 4/22; H04W 88/14

(57) ABSTRACT

A process for supporting mobile-site communication with a fixed-site in a wireless communication system wherein the mobile-site includes a controller and a plurality of transceivers is described. The process includes, at a mobile-site, assigning and programming at least one transceiver from the plurality of transceivers to monitor at least one first channel on at least one fixed-site, receiving a message on the at least one first channel identifying a call for one or more subscriber units operable in the mobile-site, assigning a second channel for the call on the mobile-site and informing the one or more subscriber units affected by the call of the assigned second channel of the call, and propagating the call on the assigned second channel to/from the subscriber units affected by the call.

### FIELD OF THE DISCLOSURE

The present disclosure relates generally to mobile communication units and systems and methods therefor, and more particularly to mobile radio communication units and systems and methods for mission critical applications.

### BACKGROUND

Wireless communication systems, for example cellular telephony or private mobile radio (PMR) communication systems, typically provide for radio telecommunication links to be arranged between two (or more) mobile subscriber units.

Wireless communication systems are distinguished over fixed communication systems, such as the public switched telephone network (PSTN), principally in that mobile subscriber units move between communication service areas and providers, and in doing so encounter varying radio propagation environments. Therefore, the quality of a communication link to/from a subscriber unit varies, for example, amongst other reasons, as the subscriber unit changes location or the environment that the subscriber is operating in is rapidly not static. The subscriber units are typically either vehicular-mounted ‘mobile’ or ‘hand-portable’ radio or cellular mobile phone units.

In wireless communications, base stations are used to communicate with mobile subscriber units and connect the mobile subscriber units to the communication infrastructure.

The term wireless coverage area identifies an extent of a geographic area where the subscriber unit can communicate with another subscriber unit or a base station can communicate with a subscriber unit. The coverage area depends on several factors, such as subscriber unit transmit power, subscriber unit receiver performance, technology and/or radio frequencies being used, propagation factors such as buildings, trees, etc. The ability of a subscriber unit to connect to a base station depends on the strength of the signal as a function of the foregoing factors.

In wireless communication systems, there are typically two methods of communicating between subscriber units. A first method is a direct communication between (at least) two subscriber units, as provided for in conventional communication in a private mobile radio (PMR) communication system. A second method uses one or more intermediary station to forward a received communication from a first subscriber unit to at least one second subscriber unit, as provided in trunked mode of operation (TMO) or repeater-based conventional communication in a PMR communication system or in a mobile cellular telephone communication system.

A radio repeater station is a known communications terminal that performs a minimal amount of processing in receiving a communication from a first subscriber unit and re-transmitting the received communication to at least one second subscriber unit. A repeater provides a mechanism to support an increased communications coverage area, for example to provide communication coverage to a subscriber unit that is operating outside of a dedicated TMO network coverage area. It is known that repeaters may be mobile or fixed and may operate using either a single dedicated frequency or a number of dedicated frequencies.

Within PMR communication systems, mission critical applications are known to provide pre-planned, sufficient grade of service (coverage, capacity, Voice/Data quality) communications in a customer-defined area. Good pre-planning would provide a considerable ‘grace’ (margin) in system resources to mitigate un-planned events. However, there are real-life situations where the pre-planned system fails to perform in the desired manner, for example due to equipment failure, prevailing weather conditions such as storms, hurricanes, etc., thereby resulting in a lack of wireless communication in an area where the system is needed most. In a number of instances, on-scene communications are a critical link in the delivery of emergency services. Lack of adequate interoperability may also be a contributing factor in rescue action failure.

Referring first to FIG. 1, a communication network 100 illustrates a known scenario where an extended communication coverage area is required, for example due to equipment failure or a requirement to extend coverage in an emergency situation. The communication network 100) comprises a variety of trunked communication cells 120, 130, 150, 160, 180 and conventional communication cells 140, 170, 190 supported by respective infrastructure components, such as base stations 122, 132, 142, 152, 162, 172, 182, 192. Notably, an area 105 fails to receive adequate communication coverage from any of the respective infrastructure components, and thus no communication to or from MS 110 is supported.

Known methods that are sometimes used to overcome a problem with lack of coverage, in scenarios such as that shown in FIG. 1, include a use of a ‘talkaround’ channel that operates in the simplex mode without benefit of a repeater, or a switch from digital mode to analog mode to extend coverage or use of mobile repeaters, neither of which is an optimal solution.

Accordingly, there is a need for a method and apparatus for extending coverage in a mobile radio communication system, for example for mission critical public safety customers to adaptively react to real-life, unplanned situations.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a known scenario where an extended communication coverage area is required to a communication network.

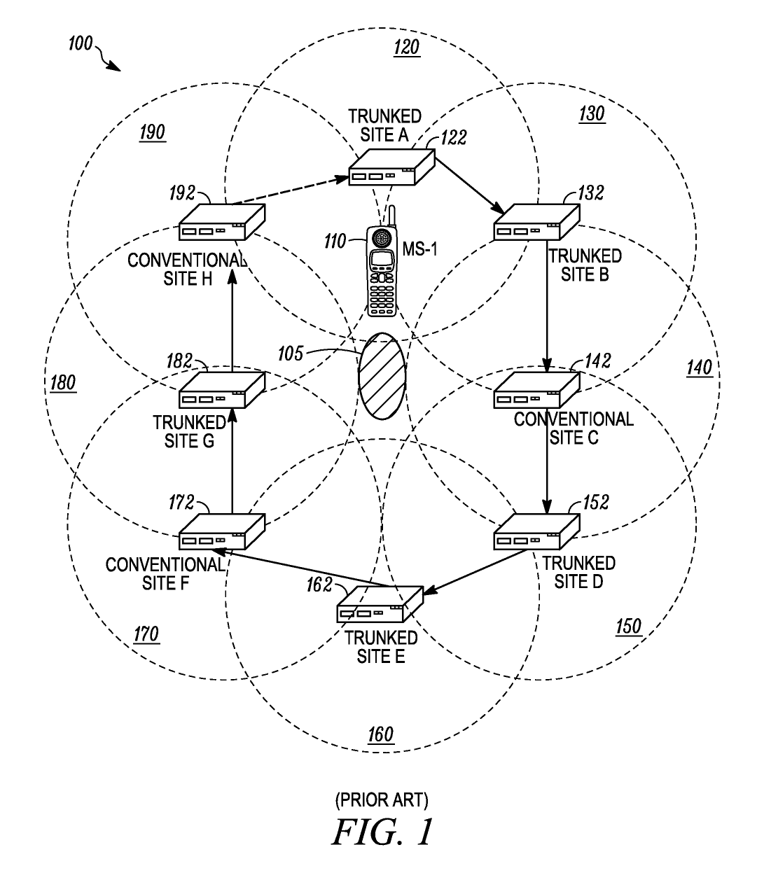

FIG. 2 is an example architectural block diagram of a controller-based mobile-site providing extended trunked communication coverage area to a fixed trunked site, for example illustrating a call starting in the fixed trunked site, in accordance with some example embodiments.

FIG. 3 is an example architectural block diagram of a controller-based mobile-site providing extended trunked communication coverage area to a fixed trunked site, for example illustrating a call starting in the mobile trunked site, in accordance with some example embodiments.

FIG. 4 is an example flowchart of a method for a controller-based mobile-site providing extended trunked communication coverage area to a fixed trunked site, in accordance with some example embodiments.

FIG. 5 is an example architectural block diagram of a controller-based mobile-site providing extended conventional communication coverage area to a fixed trunked site, in accordance with some embodiments.

FIG. 6 is a flowchart of a method for a controller-based mobile-site providing extended conventional communication coverage area to a fixed trunked site, in accordance with some embodiments.

FIG. 7 is an example architectural block diagram of a controller-based mobile-site providing extended conventional communication coverage area to a fixed conventional site in accordance with some embodiments.

FIG. 8 is a flowchart of a method for controller-based mobile-site providing extended conventional communication coverage area to a fixed conventional site in accordance with some embodiments.

FIG. 9 is an example architectural block diagram of a controller-based mobile-site providing extended trunked communication coverage area to a fixed conventional site, for example illustrating a call starting in the mobile trunked site, in accordance with some embodiments.

FIG. 10 is an example architectural block diagram of a controller-based mobile-site providing extended trunked communication coverage area to a fixed conventional site, for example illustrating a call starting in the conventional fixed-site, in accordance with some embodiments.

FIG. 11 is a flowchart of a method for a controller-based mobile-site providing extended trunked communication coverage area to a fixed conventional site in accordance with some embodiments.

FIG. 12 is an example block diagram of a controller-transceiver arrangement in accordance with some embodiments.

FIG. 13 illustrates an example of a typical computing system that may be employed to implement signal processing functionality in embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A method of supporting mobile-site communication with a fixed-site in a wireless communication system is described, wherein the mobile-site comprises a controller and a plurality of transceivers. The method comprises, at a mobile-site: assigning and programming at least one transceiver from the plurality of transceivers to monitor at least one first channel on at least one fixed-site; receiving a message on the at least one first channel identifying a call for one or more subscriber units operable in the mobile-site; assigning a second channel for the call on the mobile-site and informing the one or more subscriber units affected by the call of the assigned second channel of the call; and propagating the call on the assigned second channel to/from the subscriber units affected by the call.

In this manner, a method and various communication units provide for dynamic mobile coverage and connectivity from, in one example, a controller-based mobile extended coverage site to the (rest of the) system infrastructure is provided, thereby enabling users in an incident area where coverage was previously available, to communicate with a dispatcher and/or other users in different sites.

In one example, a controller-based mobile extended coverage site to the rest of the system infrastructure is provided, thereby enabling users in an area where there has previously been equipment failure, to communicate with a dispatcher and/or other users in different sites, for example where the mobile-site may be located within coverage range of the original fixed system.

In other examples, the mobile-site may be able to communicate with the original fixed-site via a repeater network. In this example, the repeater network is configured to operate in a normal ‘repeater’ mode of operation, perceiving the mobile-site as effectively a subscriber unit.

In one example, a controller-based mobile extended coverage site to the rest of the system infrastructure may be provided to enable dynamic creation of access points to provide connectivity to rest of the infrastructure. In one example, a controller-based mobile extended coverage site to the rest of the system infrastructure may be provided to create a bridge/link between two different radio systems, for example comprising but not limited to, public or private mobile radio, Private Broadband, long-term evolution (LTE), global system for mobile communication (GSM), a third generation (3G) system, a fourth generation system, etc. that may employ different protocols and may be in the vicinity of each other.

In one example, the controller in the mobile-site may be configured to manage multiple calls across multiple channels, for example based at least partly on call type information collected from a control channel or over multiple scanned conventional channels of the original fixed-site.

In one example application, mission critical public safety customers may adaptively react to real-life, unplanned situations, e.g. in response to an incident requiring police, medical or fire-prevention services.

In some examples, the mobile-site and the original fixed-site may support either conventional or trunked communications. Thus, examples of the invention provide a controller-based extended coverage mobile-site that is able to support at least four different operational modes, namely an original trunked system to mobile extended trunked site, an original conventional system to mobile extended trunked site, an original trunked system to mobile extended conventional site, and an original conventional system to mobile extended conventional site. In some examples, the trunked system examples may be applied to data systems employing trunking techniques, such as LTE.

In particular, examples of the invention provide for a mobile extended coverage site that is able to dynamically manage multiple calls across multiple channels at the mobile-site based on, for example, call type information collected from a control channel or over multiple scanned conventional channels of the original fixed-site system.

In one example, a conventional wireless communication system may be configured to provide a mobile extended coverage site to the rest of the system infrastructure, thereby enabling users in an incident area where coverage was not planned, or enabling users in an area where there has previously been equipment failure, to communicate with a dispatcher and/or different users in different sites.

Examples of the invention further provide for a controller-based mobile extended coverage site whereby a mobile controller is able to dynamically manage multiple channels at the mobile extended coverage site and make decision on which calls the various MSs supported by the mobile extended coverage site are to participate in, based on, for example, call type.

In one example, the at least one fixed-site may be arranged to limit a number of processed calls to the mobile extended coverage site, as the mobile extended coverage site may be configured to handle a limited number of channels. The limit on the number of processed calls may be based on at least one from a group comprising: the configuration of the mobile-site, the number of transceivers employed in the mobile extended coverage site, the type of mobile-site, the type of fixed-site, the reasons behind the setting up of the mobile-site, etc.

In one example, a call may be started in any of a number of different sites and it is transparent for mobile users.

In one example, the mobile-site controller may decide which calls should be propagated between sites, for example depending upon call priority, talk group identifier, network access code, a channel number from which a call is propagated, etc.

In one example, the example embodiments may monitor communications from at least one fixed-site to determine whether the at least one fixed-site is a trunked fixed-site or a conventional fixed-site and, in response thereto. In one example, the mobile-site controller may (then) be arranged to decide which of a plurality of transceivers may be configured to either listen to the control channel (in a trunked mode) or scan through a list of channels in the original fixed-site (in a conventional mode). The assigned at least one transceiver may be arranged to process any received signal and detect a call of interest.

In the various embodiments described herein, the terms ‘transceiver’ and ‘base station’ may be used interchangeably.

In one example, if a call of interest was detected by the mobile-site controller, the mobile-site controller may decide if this call should be propagated to the extended area and which channels should handle the call.

In one example, the mobile-site controller may decide which transceiver should be detecting calls of interest started in the original fixed-site. In some examples, the call of interest may be defined as a call to a particular talk group, with specific network access code, emergency call, etc.

In one example, the mobile-site controller may configure receive (Rx)/transmit (Tx) frequencies on the assigned at least one transceiver so that the mobile-site controller is able to listen/send signals on appropriate frequencies to the at least one original fixed-site. In one example, the assigned at least one transceiver may be configured to notify the controller about the type of calls (talkgroup identifier, Network Access Code, call priority, a channel number from which a call is propagated etc.) in the original site.

In one example, the assigned transceiver may be visible as a subscriber unit by the original (conventional or trunked) fixed-site, and it may request a voice channel on a control channel when a call is started in the extended coverage area of the mobile-site.

In one example, the example embodiments may be used to monitor and dynamically extend both trunked and non-trunked networks via the same pool of mobile-site transceivers.

In one example, the example embodiments may be employed in third generation and/or fourth generation of wireless communication technologies, such as LTE or packet-switched LTE.

In one example, the at least one fixed-site may comprise at least one from a group comprising: a public or private mobile radio, Private Broadband, long-term evolution (LTE), global system for mobile communication (GSM), a third generation (3G) system, a fourth generation system.

In one example, the mobile site may monitor more than one fixed communication system and then determine an assignment of at least one or a plurality of transceivers based on activity detected on either system (and if there is traffic on both, determine the highest priority call to route).

In some examples, monitoring more than one fixed communication system may comprise monitoring both a trunked fixed-site (control channel) and a conventional fixed-site (conventional channel(s)) in parallel, and then dynamically assigning other transceiver pairs to support one to N calls at the mobile site (depending on, for example, a number of transceiver pairs available for call traffic), and then acting on calls of interest. For example, a controller in the mobile site may be configured with known control channel frequencies of nearby trunked radio systems and with known conventional channel frequencies of nearby conventional radio systems, and may be configured to periodically or intermittently scan through all frequencies, using one or more of the transceivers at its disposal, looking for new call notifications, among other possibilities on the known control and conventional channels.

In one example, a controller in the mobile-site may be configured to collate information on the subscriber units that are operational in the mobile-site, and forward the mobile-site subscriber unit information to the original fixed-site, to enable the fixed-site to route communications accordingly.

In one example, a controller in the mobile-site may be configured to provide a subscriber unit in the mobile-site with information identifying a source of a call.

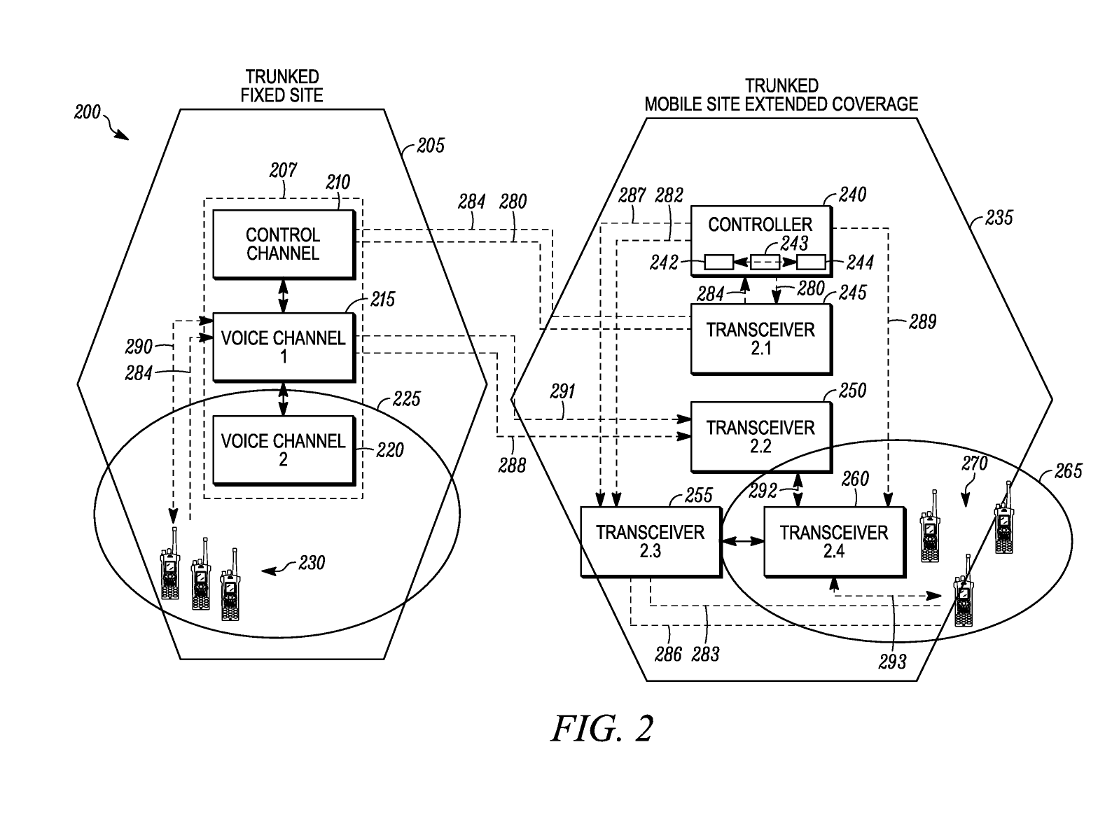

FIG. 2 illustrates an example architectural block diagram 200 of a controller-based mobile-site 235 providing extended trunked communication coverage area to a trunked fixed-site 205, in accordance with some example embodiments. The controller-based mobile-site 235 comprises a controller 240 operably coupled to a first transceiver 245, a second transceiver 250, a third transceiver 255 and a fourth transceiver 260. The controller 240 may comprise at least one control module (which in some examples may comprise a scheduling module or processor) 242, a signal processing module 243 and a wireless transceiver interface 244. In some examples, the at least one control module may be implemented as an integrated circuit 242. The example architectural block diagram 200 comprises an illustrative extended coverage area 265 supported by fourth transceiver 260 communicating with a plurality of mobile-site subscriber units 270.

The trunked fixed-site 205 illustrates a base station 207 supporting a control channel 210, a first voice channel 215 and a second voice channel 220. The base station 207 comprises an illustrative extended coverage area 225 communicating with a plurality of subscriber units 230.

In one example scenario illustrated in FIG. 2, a call is started in the trunked fixed-site 205. In this example, the mobile-site controller 240 configures (by at least instructing to re-program or re-programming the transceiver's transmit/receive frequencies), via communication path 280, a first transceiver 245 of mobile-site 235 to pair with the control channel 210 in the original trunked fixed-site 205. In this manner, the mobile-site is able to detect activity in the original trunked fixed-site 205 as well as request resources from the original trunked fixed-site 205.

The mobile-site controller 240 selects the third transceiver 255, via communication path 282, to function as control channel in the mobile-site 235, (by at least instructing to re-program or re-programming the third transceiver's transmit/receive frequencies), which, in turn, is relayed via communication path 283 to the subscriber units 270 in the mobile-site 235. In this manner, the assigned first transceiver 245 may be visible as a subscriber unit in the original trunked fixed-site 205, for example when requesting a channel. The subscriber units 270 in the mobile-site 235 thereafter listen to the third transceiver 255 for control channel information.

At least one subscriber unit 230 located in the trunked fixed-site 205 starts a call, via communication path 284, and therefore the at least one subscriber unit 230 requests resources. Thus, the fixed site assigns a first voice channel 215 (which includes both an uplink channel and repeated downlink channel) and the control channel 210 is used to indicate the assigned first voice channel 215 as the dedicated channel for this call. This information is broadcasted over the air so that the first transceiver 245 (in addition to any subscriber units 230 participating in the call) receives this information and informs the mobile-site controller 240.

The mobile-site controller 240 decodes the call and determines that this call is relevant to the mobile-site 235, perhaps due to a determination that at least one of the mobile site subscribers 270 is active and subscribed to or affiliated with a same group as to which the call is directed or affiliated with. In other examples, additional or alternative rules may be applied, for example a call may be relevant to the mobile-site when it is an emergency call or for a particular talk group, with a particular Network Access Code, etc. The mobile-site controller 240 therefore decides to propagate the call into the mobile-site cell 265. Hence, mobile-site controller 240 assigns, via communication path 287, the mobile-site control channel to be the third transceiver 255 in this example, which thereafter informs the mobile-site subscribers 270, via communication path 286, that a call is directed to the (or a number of the) mobile-site subscriber(s) 270 and will be started through fourth transceiver 260 (which is dedicated as a voice channel 289 for this purpose). One or more of the mobile-site subscribers 270 therefore switch to communicating with fourth transceiver 260 on voice channel 289 and receive the call.

The mobile-site controller 240 also configures, via communication path 288, second transceiver 250 to be the communication link between the mobile-site 235 and the trunked fixed-site 205 so that second transceiver 250 can directly receive communications broadcast on the first voice channel 215 of the trunked fixed-site 205 and provide them to the fourth transceiver for re-broadcast at the mobile site.

The extended coverage for the call to/from one or more of the plurality of subscriber units 230 is thus achieved via the uplink communication path 290 between the at least one subscriber unit 230 and the first voice channel 215, the downlink established call path 291 between the first voice channel 215 of the trunked fixed-site 205 through second transceiver 250 via established call path 292, and the voice channel 293 between the fourth transceiver 260 to/from mobile-site subscriber(s) 270.

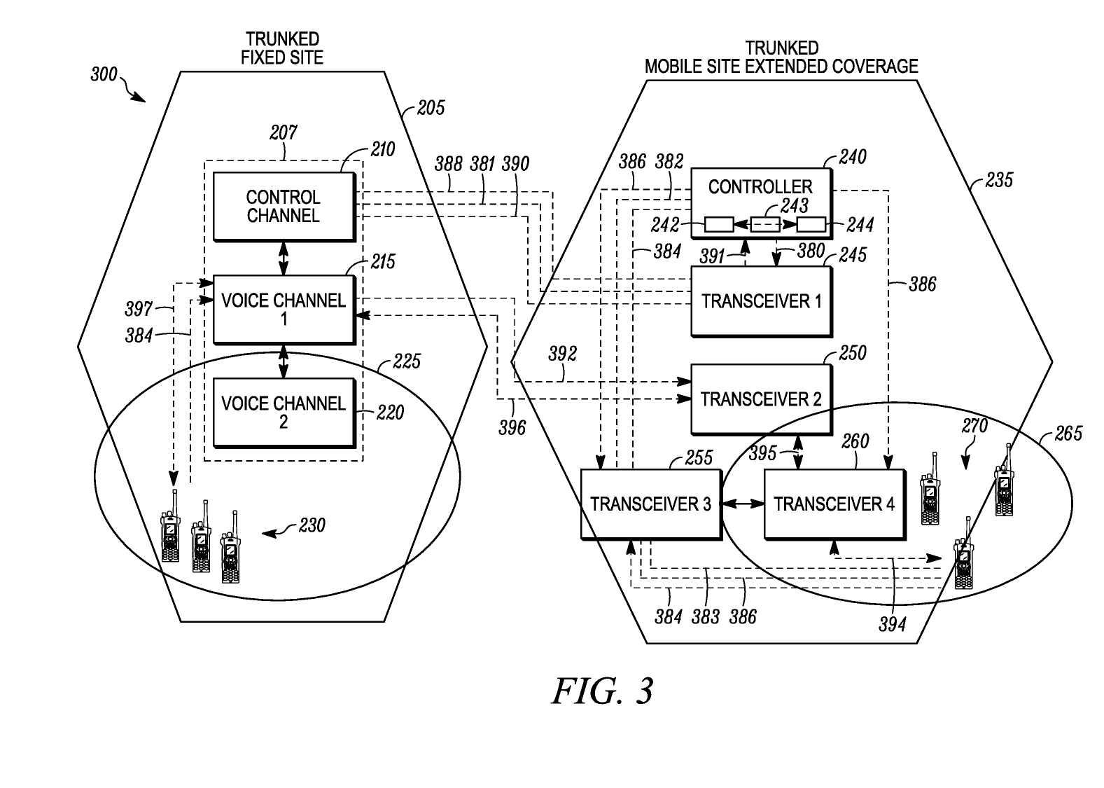

FIG. 3 illustrates an example architectural block diagram 300 of a controller-based mobile-site 235 providing extended trunked communication coverage area to a trunked fixed-site 205, in accordance with some example embodiments. The controller-based mobile-site 235 comprises a controller 240 operably coupled to a first transceiver 245, a second transceiver 250, a third transceiver 255 and a fourth transceiver 260. The controller 240 may comprise at least a control module (which in some examples may comprise a scheduling module or processor) 242, a signal processing module 243 and a wireless transceiver interface 244. In some examples, the at least one control module may be implemented as an integrated circuit 242. The example architectural block diagram 200 comprises an illustrative extended coverage area 265 supported by fourth transceiver 260 communicating with a plurality of mobile-site subscriber units 270.

The trunked fixed-site 205 illustrates a base station 207 supporting a control channel 210, a first voice channel 215 and a second voice channel 220. The base station 207 comprises an illustrative extended coverage area 225 communicating with a plurality of subscriber units 230.

In one example scenario illustrated in FIG. 3, a call is started in the mobile-site 235. In this example scenario, the mobile-site controller 240 has previously configured (by at least instructing to re-program or re-programming the transceiver's transmit/receive frequencies), via communication path 380, first transceiver 245 of mobile-site 235 to pair via communication path 381 with the control channel 210 in the original trunked fixed-site 205. In this manner, the mobile-site is able to detect activity in the original trunked fixed-site 205 as well as request resources from the original trunked fixed-site 205.

Then mobile-site controller 240 selects, via communication path 382, the third transceiver 255 to function as control channel in the mobile-site 235, via broadcast control channel 383. In this manner, the first transceiver 245 assigned via communication path 380, may be visible as a subscriber unit in the original trunked fixed-site 205, for example when requesting a channel. The mobile-site subscriber units 270 in the mobile-site 235 thereafter listen to the third transceiver 255 for control channel information.

Then, via communication path 384, at least one subscriber unit 270 located in the trunked mobile-site 235 starts a call and therefore the at least one subscriber unit 270 requests resources, for example access to a dedicated voice channel. Thus, third transceiver 255 informs the mobile-site controller 240 of the call.

Then, via communication path 386, the mobile-site controller 240 decides to allocate resources for this call with fourth transceiver 260 as the voice channel. This allocation is transmitted to the at least one subscriber unit 270 through the control channel in the mobile-site 235 (for example the third transceiver 255 in this example).

Then, via communication path 388, in addition to allocating resources into the mobile-site 235, the mobile-site controller 240 determines whether to propagate the call into the original trunked fixed-site 205 using one or more known methods, such as maintaining a pre-configured or dynamically created mapping between talkgroups subscribed to by active mobile devices in its service area or between channels used by active mobile devices in its service area and whether new calls to those talkgroups or on those channels should be propagated to the fixed-site. Dynamically creating the mapping could be accomplished via instructions to create the mapping received directly from the fixed-site or directly from active mobile devices at the mobile site, or received via a separate IP connection with a mobile site configurator, among other possibilities. Assuming the mobile site determines that the call should be propagated to the fixed site, the mobile-site controller 240 instructs first transceiver 245 to request a voice channel in the original trunked fixed-site 205.

The control channel 210 in the original trunked fixed-site 205 assigns the first voice channel 215 for this mobile-site originating call, and informs, via communication path 390, the first transceiver 245 in the mobile-site 235. The first transceiver 245 then informs via communication path 391, the mobile-site controller 240.

The mobile-site controller 240 thus configures the second transceiver 250 to be the communication link 392 between the mobile-site 235 and the trunked fixed-site 205, so that second transceiver 250 is able to directly transmit communications on the first voice channel 215 of the trunked fixed-site 205.

Thus, the extended coverage for the call to/from one or more of the plurality of mobile-site subscriber units 270 is achieved via the established call path 394 between the one of the plurality of mobile-site subscriber units 270 and the fourth transceiver 260, the established call path 395 between the fourth transceiver 260 through second transceiver 250 and established call path 396 through first voice channel 215 of the trunked fixed-site and to/from fixed-site subscriber(s) 230 via voice channel 397.

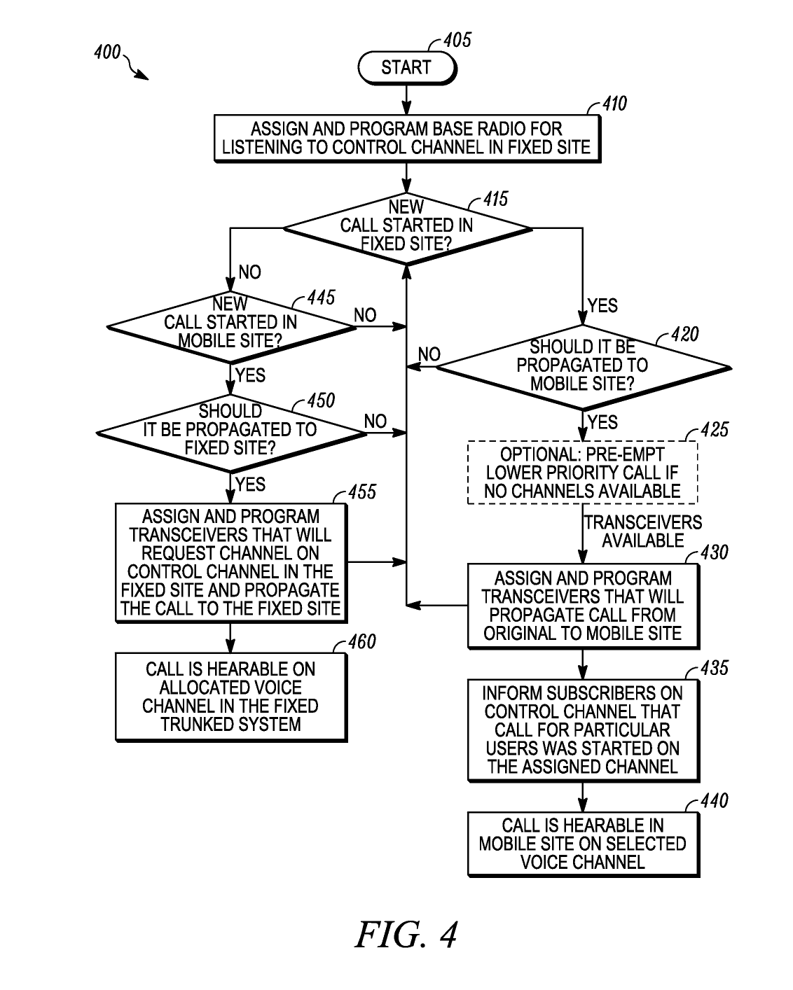

FIG. 4 is a flowchart 400 of a method for a controller-based mobile-site to provide extended trunked communication coverage area to a fixed trunked site, in accordance with some example embodiments. The flowchart 400 commences in 405 and moves to 410 when a base station is assigned and programmed for listening to a control channel on the original trunked fixed-site. In this manner, the base station listens for new call requests on the original trunked fixed-site, in 415. In some examples, the call request may identify at least one from a group comprising: a talk group, a network access code, a call type.

In this mode of operation, the base station broadcasts the new call information on the control channel or conventional channel (depending on the type of fixed site). The controller in the mobile-site is then able to determine that a new call is started in the original trunked fixed-site, in 415, and determines whether to assign transceivers and propagate the call to the trunked mobile-site (for example based on known information about active subscriber units in the mobile site, such as group affiliation, or transceiver availability) in 420. If the call should not be propagated to the trunked mobile-site in 420, the flowchart loops back to 415. If the call is to be propagated to the trunked mobile-site in 420, the controller in the mobile-site determines whether to optionally pre-empt a lower priority call if no channels are available in 425. If transceivers are available, a controller in the mobile-site assigns and programs at least one transceiver in the mobile-site to propagate the call from the base station in the original trunked fixed-site to subscriber units in the trunked mobile-site in 430. A controller in the trunked mobile-site then arranges for the subscriber units affected by the call to be informed on the trunked mobile-site control channel that the call for certain subscriber units is started on an assigned channel, in 435. The call is then receivable on the selected voice channel by the subscriber units affected by the call in 440.

In this mode of operation, if the base station determines that a new call is not started in the original trunked fixed-site, in 415, a controller in the trunked mobile-site determines whether a call is started in the mobile-site in 445. If there is no call started from the mobile-site in 445, the flowchart loops back to 415. If there is a call started from the mobile-site in 445, a determination is made as to whether the call should be propagated to the trunked fixed-site in 450. If the call is to be propagated to the trunked fixed-site in 450, the mobile-site controller assigns and programs the transceivers to request a channel on the fixed-site control channel and thereafter propagates the call via first and second assigned transceivers (for example one to link with the subscriber units and one to link with the fixed site) in the trunked mobile-site to a base station in the trunked fixed-site in 455. The call is then made receivable on an allocated voice channel in the trunked fixed-site in 460.

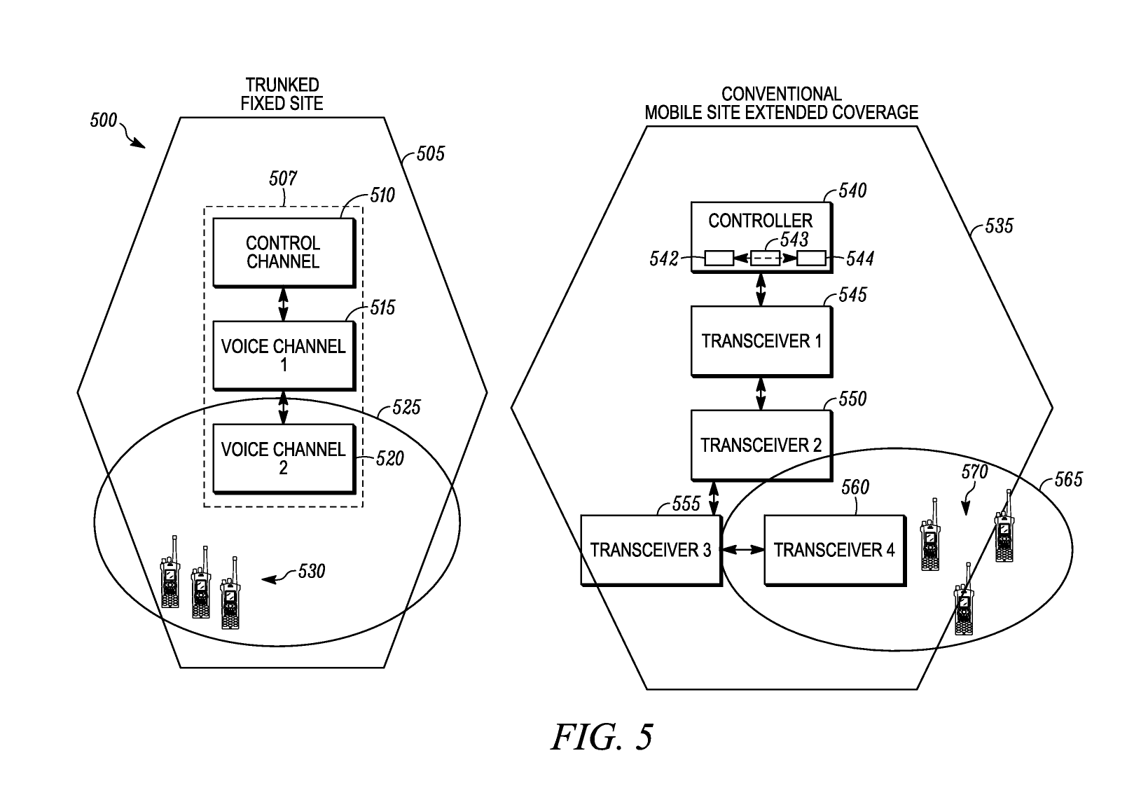

FIG. 5 illustrates an example architectural block diagram 500 of a controller-based mobile-site 535 providing an extended conventional communication coverage area to a trunked fixed-site 505, in accordance with some example embodiments. The controller-based mobile-site 535 comprises a controller 540 operably coupled to a first transceiver 545, a second transceiver 550, a third transceiver 555 and a fourth transceiver 560. The controller 540 may comprise at least a control module (which in some examples may comprise a scheduling module or processor) 542, a signal processing module 543 and a wireless transceiver interface 544. In some examples, the at least one control module may be implemented as an integrated circuit 542. The example architectural block diagram 500 comprises an illustrative extended coverage area 565 supported by fourth transceiver 560 communicating with a plurality of mobile-site subscriber units 570.

The trunked fixed-site 505 illustrates a base station 507 supporting a control channel 510, a first voice channel 515 and a second voice channel 520. The base station 507 comprises an illustrative extended coverage area 525 communicating with a plurality of subscriber units 530.

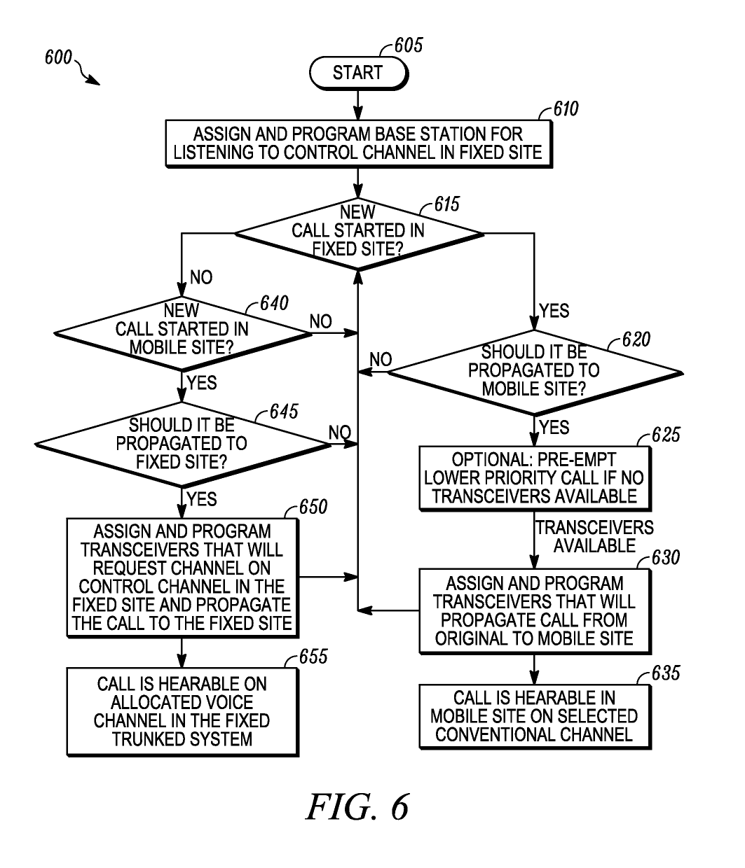

One operational example of the architecture of FIG. 5 is described in FIG. 6. FIG. 6 is a flowchart 600 of a method for a controller-based mobile-site (such as controller-based mobile-site 535 of FIG. 5) providing extended conventional communication coverage area to a fixed trunked site (such as trunked fixed-site 505 of FIG. 5), in accordance with some embodiments. The flowchart 600 commences in 605 and moves to 610 when a transceiver is assigned and programmed to listen to a control channel in the original trunked fixed-site. In this manner, a base station in the fixed-site listens for new call requests on the original trunked fixed-site, in 615. In some examples, the call request may identify at least one from a group comprising: a talk group, a network access code, a call type. In this mode of operation, the base station broadcasts the new call information on the control channel (or conventional channel depending on the type of fixed site). The controller in the mobile-site is then able to determine that a new call is started in the original trunked fixed-site, in 615. The controller in the mobile-site determines whether to assign transceivers and propagate the call to the conventional mobile-site (for example based on known information about active subscriber units in the mobile site, such as group affiliation, or transceiver availability) in 620. If the call should not be propagated to the conventional mobile-site in 620, the flowchart loops back to 615. If the call is to be propagated to the conventional mobile-site in 620, the controller in the mobile-site base station in determines whether to optionally pre-empt any lower priority call in the mobile-site if no channels are available in 625. If transceivers are available, the controller at the mobile-site assigns and programs first and second transceivers to propagate the call from the base station in the original trunked fixed-site to a transceiver in the conventional mobile-site in 630. The call is then receivable on the selected voice channel by the subscriber units affected by the call in 635.

In this mode of operation, if the base station determines that a new call is not started in the original trunked fixed-site, in 615, the controller in the mobile-site determines whether a call is started in the mobile-site in 640. If there is no call started from the conventional mobile-site in 640, the flowchart loops back to 615. If there is a call started from the mobile-site in 640, a determination is made, by the controller, as to whether the call should be propagated to the trunked fixed-site in 645, perhaps in a similar manner as to that already set forth above. If the call is to be propagated to the trunked fixed-site in 645, the mobile-site controller assigns and programs the transceivers to request a channel on the fixed-site control channel and thereafter propagate the call from the transceiver in the conventional mobile-site to a base station in the trunked fixed-site in 650. The call is then made receivable on an allocated voice channel in the trunked fixed-site in 655.

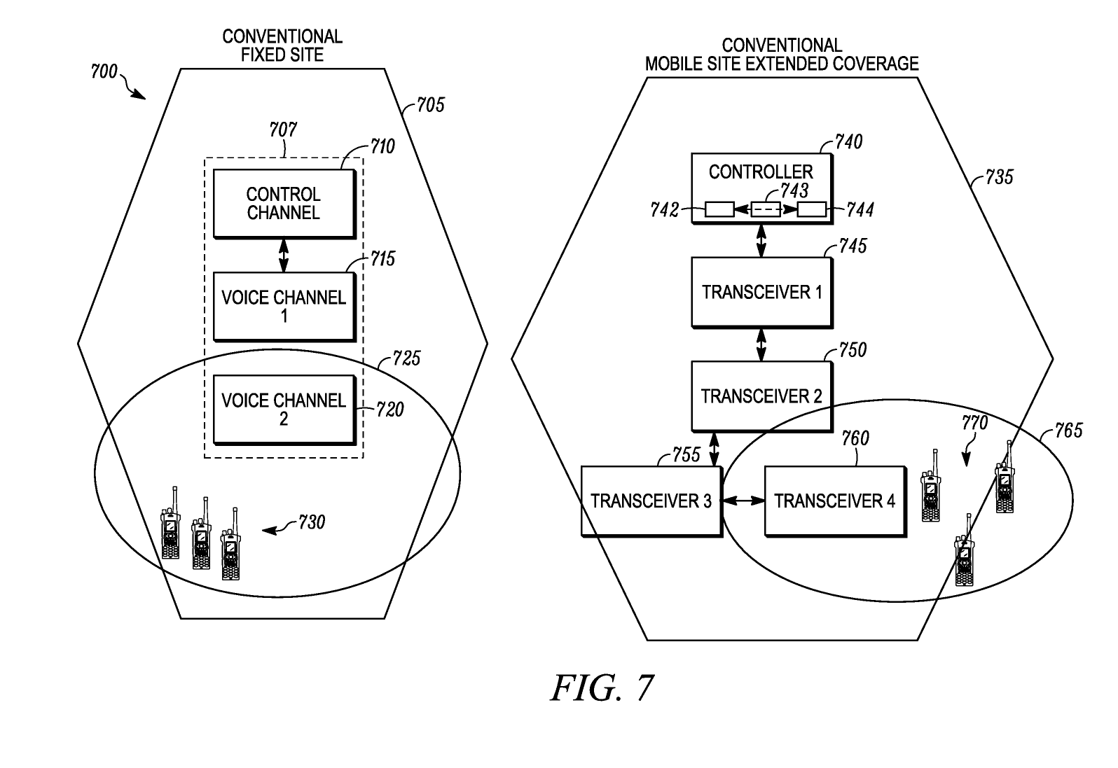

FIG. 7 illustrates an example architectural block diagram 700 of a controller-based mobile-site 735 providing an extended conventional communication coverage area to a conventional fixed-site 705, in accordance with some example embodiments. The controller-based mobile-site 735 comprises a controller 740 operably coupled to a first transceiver 745, a second transceiver 750, a third transceiver 755 and a fourth transceiver 760. The controller 740 may comprise at least a control module (which in some examples may comprise a scheduling module or processor) 742, a signal processing module 743 and a wireless transceiver interface 744. In some examples, the at least one control module may be implemented as an integrated circuit 742. The example architectural block diagram 700 comprises an illustrative extended coverage area 765 supported by fourth transceiver 760 communicating with a plurality of mobile-site subscriber units 770.

The conventional fixed-site 705 illustrates a base station 707 supporting a first channel 710, a second channel 715 and a third channel 720. The base station 707 comprises an illustrative extended coverage area 725 communicating with a plurality of subscriber units 730.

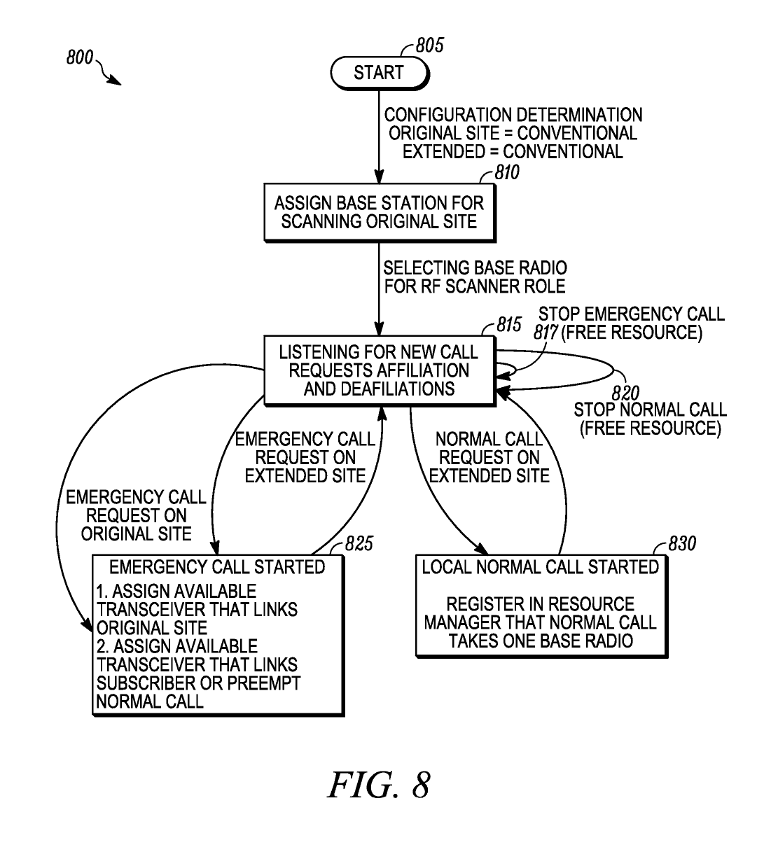

One operational example of the architecture of FIG. 7 is described in FIG. 8. FIG. 8 is a flowchart 800 of a method for controller-based mobile-site (such as controller-based mobile-site 735 of FIG. 7) providing extended conventional communication coverage area to a fixed conventional fixed-site (such as conventional fixed-site 705 of FIG. 7) in accordance with some embodiments. The flowchart 800 commences in 805 and moves to 810 when a base station is assigned for scanning radio frequency (RF) channels in the original conventional fixed-site. In this manner, the base station listens for new call requests, affiliations and de-affiliations on the scanned radio frequency (RF) channels on the original conventional fixed-site, in 815. In some examples, the call request may identify at least one from a group comprising: a talk group, a network access code, a call type, e.g. an emergency call. In this mode of operation, the base station stops any emergency calls in 817 or stops any normal calls in 820 in order to free up resources to listen new call requests, affiliations and de-affiliations on the scanned radio frequency (RF) channels on the original conventional fixed-site.

If, in this mode of operation, the base station receives an emergency call request from either the original site or the extended site, the base station commences an emergency call process in 825. The emergency call process 825 comprises assigning an available transceiver in the conventional mobile-site to link to the original site, as well as assigning an available transceiver in the conventional mobile-site to link to the subscriber unit. In one example, the emergency call process 825 may comprise prioritizing the calls across available mobile-site resources based at least partly on the call request, for example when the call request is an emergency call request received from either the fixed-site or the mobile-site, by pre-empting a normal call.

If, in this mode of operation, the base station receives a normal call request from the extended site, the base station commences a normal call process in 830. The normal call process 830 comprises registering the use of a base station in a resource manager.

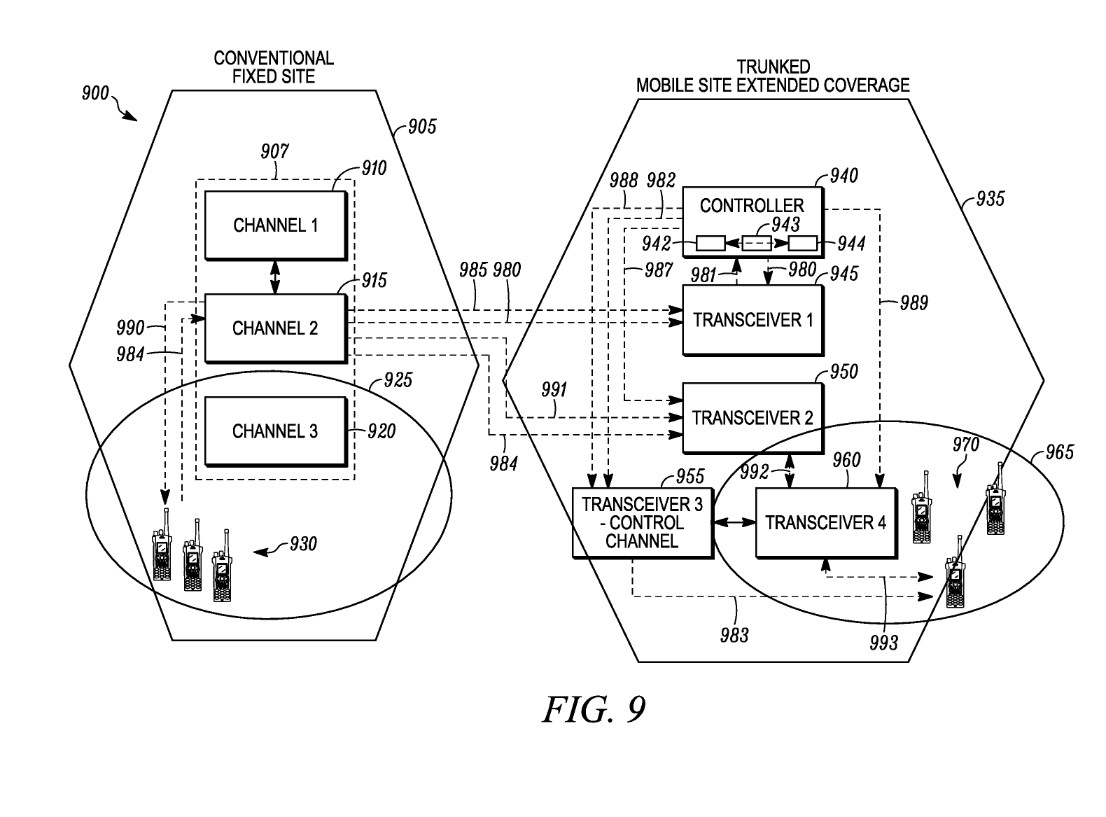

FIG. 9 illustrates an example architectural block diagram 900 of a controller-based mobile-site 935 providing an extended trunked communication coverage area to a conventional fixed-site 905, in accordance with some example embodiments. The controller-based mobile-site 935 comprises a controller 940 operably coupled to a first transceiver 945, a second transceiver 950, a third transceiver 955 and a fourth transceiver 960. The controller 940 may comprise at least a control module (which in some examples may comprise a scheduling module or processor) 942, a signal processing module 943 and a wireless transceiver interface 944. In some examples, the at least one control module 942 may be implemented as an integrated circuit. The example architectural block diagram 900 comprises an illustrative extended coverage area 965 supported by fourth transceiver 960 communicating with a plurality of mobile-site subscriber units 970.

The conventional fixed-site 905 illustrates a base station 907 supporting a control channel 910, a first voice channel 915 and a second voice channel 920. The base station 907 comprises an illustrative extended coverage area 925 communicating with a plurality of subscriber units 930.

In one example scenario illustrated in FIG. 9, a call is started in the conventional fixed-site 905. In this example, the mobile-site controller 940 configures in 980, a first transceiver 945 of mobile-site 935 to scan through all channels 910 in the conventional fixed-site 905. In this manner, via communication path 985 and via communication path 981, the mobile-site 935 is able to detect activity in the original conventional fixed-site 905.

The mobile-site controller 940 selects, via communication path 982, the third transceiver 955 to function as control channel in the mobile-site 935. In this manner, the second transceiver 950 assigned via communication path 987 may be visible as a subscriber unit in the original trunked fixed-site 905, for example when requesting a channel. The subscriber units 970 in the mobile-site 935 thereafter listen to the third transceiver 955 via communication path 983, for control channel information.

At least one subscriber unit 930 located in the conventional fixed-site 905 starts a call on voice channel 2 915 via communication path 984. The call information is repeated over the air, via communication path 985, so that the first transceiver 945 in the mobile-site 935 receives this information and informs the mobile-site controller 940 via communication path 981.

The mobile-site controller 940 decodes the call and determines that this call is relevant to the mobile-site 935, perhaps due to a determination that at least one of the mobile site subscribers 970 is active and subscribed to or affiliated with a same group as to which the call is directed or affiliated with. In other examples, additional or alternative rules may be applied, for example a call may be relevant to the mobile-site when it is an emergency call or for a particular talk group, with a particular Network Access Code, etc. The mobile-site controller 940 therefore decides to propagate the call into the mobile-site cell 965. Hence, the mobile-site controller 940 uses mobile-site control channel (i.e. third transceiver 955 in this example), via communication path 988, to inform the mobile-site subscribers 970 that a call is directed to the (or a number of the) mobile-site subscriber(s) 970. The mobile-site controller 940 also informs the mobile-site subscribers 970, via communication path 989, that the voice call will be started through fourth transceiver 960 (which is dedicated as a voice channel 993 for this purpose). One or more of the mobile-site subscribers 970 therefore switch to communicating with fourth transceiver 960 via voice channel 993.

The mobile-site controller 940 also configures, via communication path 987, second transceiver 950 (by at least instructing to re-program or re-programming the transceiver's transmit/receive frequencies) to be (paired, i.e.) the link between the mobile-site 935 and the conventional fixed-site 905 so that second transceiver 950 can directly receive communications from the second voice channel 915 of the conventional fixed-site 905.

The extended coverage for the call to/from one or more of the plurality of subscriber units 930 is thus achieved via the uplink established call path 990 between the one of the subscriber units 930 and the second voice channel 915, and the downlink established call path 991 between the second voice channel 915 of the conventional fixed-site 905 through second transceiver 950 via downlink established call path 992 and through fourth transceiver 960 to/from mobile-site subscriber(s) 970 via voice channel 993.

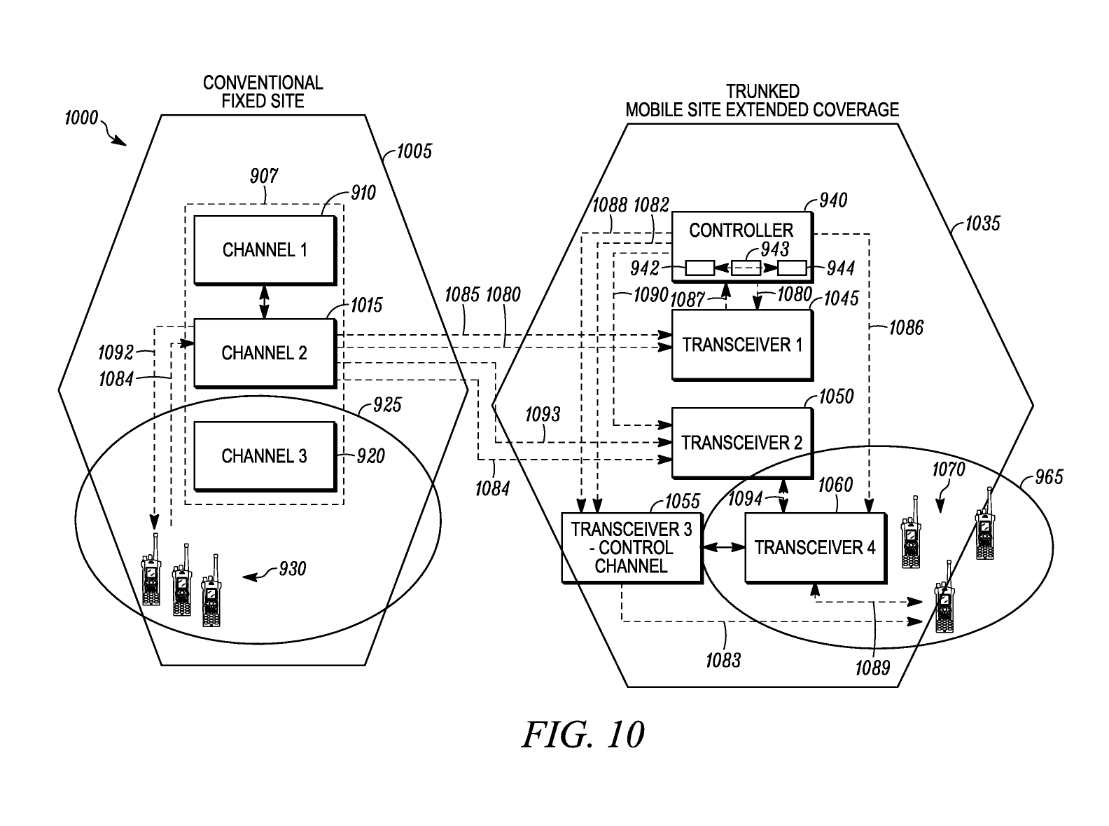

FIG. 10 illustrates an example architectural block diagram 1000 of a controller-based mobile-site 935 providing an extended trunked communication coverage area to a conventional fixed-site 905, in accordance with some example embodiments. The controller-based mobile-site 935 comprises a controller 940 operably coupled to a first transceiver 945, a second transceiver 950, a third transceiver 955 and a fourth transceiver 960. The controller 940 may comprise at least a control module (which in some examples may comprise a scheduling module or processor) 942, a signal processing module 943 and a wireless transceiver interface 944. In some examples, the at least one control module may be implemented as an integrated circuit 942. The example architectural block diagram 900 comprises an illustrative extended coverage area 965 supported by fourth transceiver 960 communicating with a plurality of mobile-site subscriber units 970.

The conventional fixed-site 905 illustrates a base station 907 supporting a control channel 910, a first voice channel 915 and a second voice channel 920. The base station 907 comprises an illustrative extended coverage area 925 communicating with a plurality of subscriber units 930.

In one example scenario illustrated in FIG. 10, a call is started in the extended trunked fixed-site 935. In this example, the mobile-site controller 940 configures, via communication path 1080, a first transceiver 1045 of mobile-site 1035 to scan through all channels 910, 915, 920 in the conventional fixed-site 905. In this manner, the mobile-site 1035 is able to detect activity in the original conventional fixed-site 1005.

The mobile-site controller 1040 selects, via communication path 1082 the third transceiver 1055 to function as control channel in the mobile-site 1035, via broadcast control channel 1083. In this manner, the second transceiver 1050 assigned via communication path 1090 may be visible as a subscriber unit in the original conventional fixed-site 1005, for example when requesting a channel. The mobile-site subscriber units 1070 in the mobile-site 1035 thereafter listen to the third transceiver 1055 for control channel information.

At least one subscriber unit 1030 located in the conventional fixed-site 1005 starts a call on voice channel 2 1015 via communication path 1084. The call information is repeated over the air via communication path 1085 so that the first transceiver 1045 in the mobile-site 1035 receives this information and informs the mobile-site controller 1040 via communication path 1087.

The controller 940 in the mobile-site is then able to determine that a new call is started in the original trunked fixed-site 905. The controller 940 in the mobile-site 935 decodes the call and determines whether to assign transceivers and propagate the call to the conventional mobile-site 935 (for example based on known information about active subscriber units in the mobile site, such as group affiliation, or transceiver availability). In other examples, additional or alternative rules may be applied, for example a call may be relevant to the mobile-site when it is an emergency call or for a particular talk group, with a particular Network Access Code, etc. The mobile-site controller 1040 therefore decides to propagate the call into the mobile-site cell 1065. Hence, the mobile-site controller 1040 uses mobile-site control channel (i.e. third transceiver 1055 in this example), via communication path 1088, to inform the mobile-site subscribers 1070), via communication path 1083, that a call is directed to the (or a number of the) mobile-site subscriber(s) 1070. The mobile-site controller 940 also informs the mobile-site subscribers 970, via communication path 1086, that the voice call will be started through fourth transceiver 1060 (which is dedicated as a voice channel 1089 for this purpose). One or more of the mobile-site subscribers 1070 therefore switch to communicating with fourth transceiver 1060 on voice channel 1089 to receive the call.

In 1088, the mobile-site controller 1040 also configures, via communication path 1090, second transceiver 1050 (by at least instructing to re-program, or re-programming, the transceiver's transmit/receive frequencies) to be (paired, i.e.) the communication path 1093 between the mobile-site 1035 and the trunked fixed-site 1005 so that second transceiver 1050 can directly receive communications from the second voice channel 1015 of the conventional fixed-site 1005.

The extended coverage for the call to/from one or more of the plurality of subscriber units 1030 is thus achieved via the uplink established call path 1092 between the one of the subscriber units 930 and the second voice channel 1015, and the downlink established call path 1093 between the second voice channel 1015 of the conventional fixed-site 1005 through second transceiver 1050 via downlink established call path 1094 and through fourth transceiver 1060 to/from mobile-site subscriber(s) 1070 via voice channel 1089.

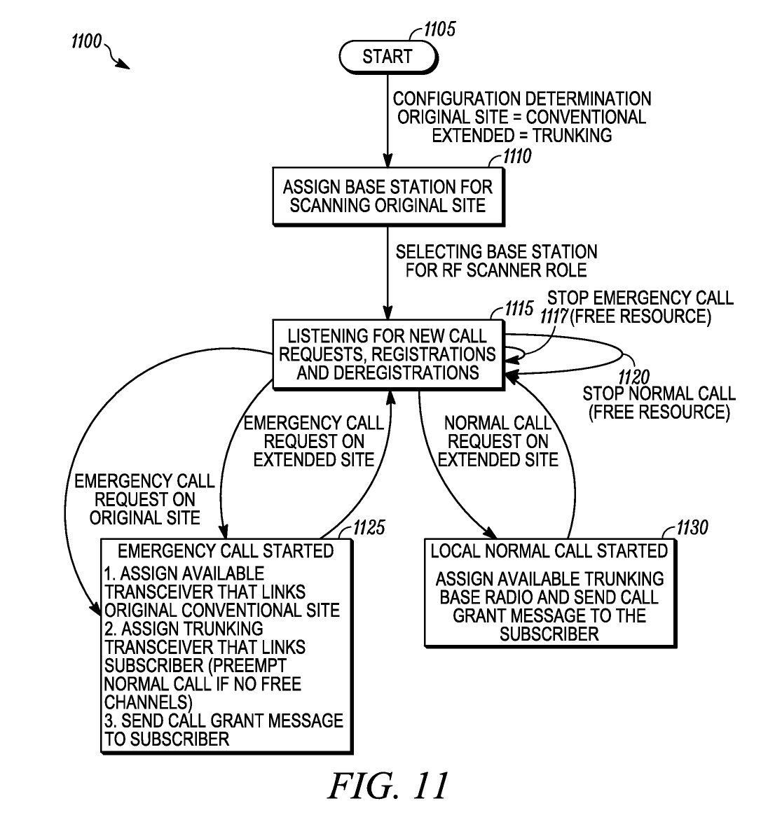

FIG. 11 illustrates a flowchart 1100 of a method for a controller-based mobile-site providing extended trunked communication coverage area to a fixed conventional site in accordance with some embodiments. The flowchart 1100 commences in 1105 and moves to 1110 when a base station is assigned for scanning radio frequency (RF) channels on the original conventional fixed-site. In this manner, the base station listens for new call requests, affiliations and de-affiliations on the scanned radio frequency (RF) channels on the original conventional fixed-site, in 1115. In some examples, the call request may identify at least one from a group comprising: a talk group, a network access code, a call type, e.g. an emergency call. In this mode of operation, the base station stops any emergency calls in 117 or stops any normal calls in 1120 in order to free up resources to listen new call requests, affiliations and de-affiliations on the scanned radio frequency (RF) channels on the original conventional fixed-site.

If, in this mode of operation, the base station receives an emergency call request from either the original site or the extended site, the base station commences an emergency call process in 1125. The emergency call process 1125 comprises assigning an available transceiver in the trunked mobile-site to link to the conventional fixed-site, as well as assigning an available transceiver in the trunked mobile-site to link to the subscriber unit. In one example, the emergency call process 1125 may comprise prioritizing the call across available mobile-site resources based at least partly on the call request, for example when the call request is an emergency call request received from either the fixed-site or the mobile-site, by pre-empting a normal call if there are no free/available channels. The emergency call process 1125 further comprises sending a call grant message to the subscriber unit(s) in the mobile-site that is/are affected by the emergency call.

If, in this mode of operation, the base station receives a normal call request from the extended mobile-site, the base station commences a normal call process in 1130. The normal call process 1130 comprises assigning an available trunked transceiver/base station for the normal call and sending a call grant message to the subscriber unit(s) in the mobile-site that is/are affected by the normal call.

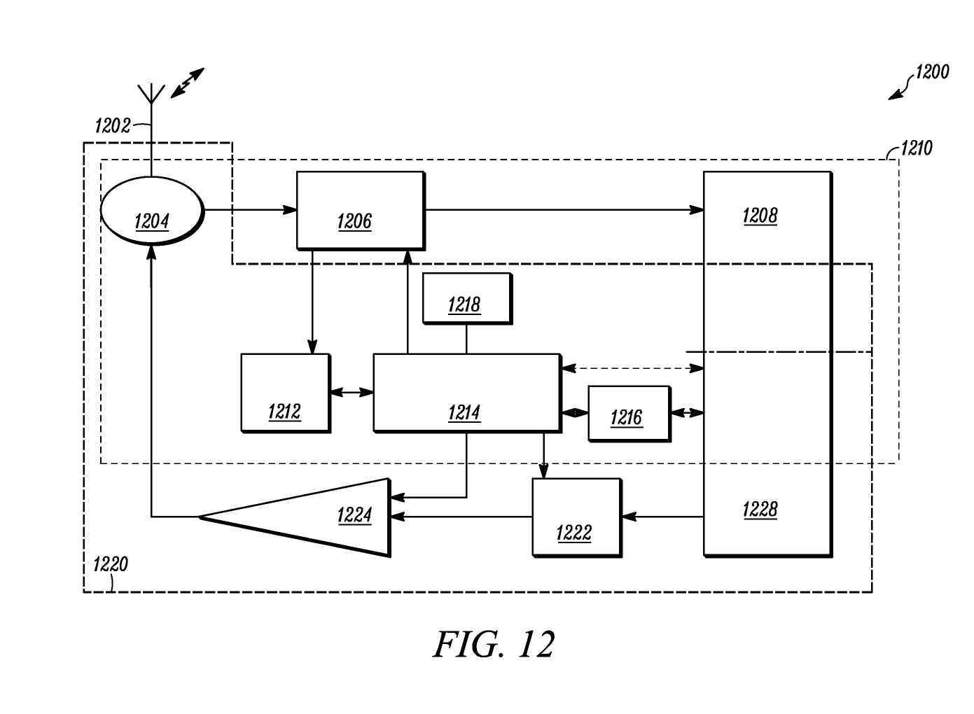

Referring now to FIG. 12, an example block diagram of a transceiver 1200 in accordance with some embodiments is shown. In practice, purely for the purposes of explaining embodiments of the invention, the transceiver 1200 is described in terms of a wireless base station. The transceiver 1200 contains an antenna 1202 coupled to an antenna switch or duplexer 1204 that provides isolation between receive and transmit chains within the transceiver 1200. One or more receiver chains, as known in the art, include receiver front-end circuitry 1206 (effectively providing reception, filtering and intermediate or base-band frequency conversion). The receiver front-end circuitry 1206 is coupled to a signal processing logic 1208 (generally realized by a digital signal processor (DSP)). A skilled artisan will appreciate that the level of integration of receiver circuits or components may be, in some instances, implementation-dependent.

The controller 1214 maintains overall operational control of the transceiver 1200. The controller 1214 is also coupled to the receiver front-end circuitry 1206 and the signal processing logic 1208. In some examples, the controller 1214 is also coupled to a buffer module 1217 and a memory device 1216 that selectively stores operating regimes, such as decoding/encoding functions, channel identifiers, transmit/receive frequency, and the like. A timer 1218 is operably coupled to the controller 1214 to control the timing of operations (transmission or reception of time-dependent signals) within the transceiver 1200.

As regards the transmit chain, this essentially includes an input module 1220, coupled in series through transmitter/modulation circuitry 1222 and a power amplifier 1224 to the antenna 1202, antenna array, or plurality of antennas. The transmitter/modulation circuitry 1222 and the power amplifier 1224 are operationally responsive to the controller 1214.

In some examples, the signal processing logic 1208 may be located on an integrated circuit (not shown). The signal processing logic 1208 in the transmit chain may be implemented as distinct from the signal processor in the receive chain. Alternatively, a single processor may be used to implement a processing of both transmit and receive signals, as shown in FIG. 12. Clearly, the various components within the transceiver 1200 can be realized in discrete or integrated component form, with an ultimate structure therefore being an application-specific or design selection.

In accordance with example embodiments of the invention, the transceiver 1200 is responsive to instructions and/or programming from the mobile-site controller, in order to communicate with subscriber units located within the mobile-site and form a communication link between such subscriber units and communication units (e.g. subscriber units and/or base stations) located within the fixed-site.

Thus, in accordance with examples embodiments, a method of supporting mobile-site communication with a fixed-site in a wireless communication system is described, wherein the mobile-site comprises a controller and a plurality of transceivers. The method comprises, at a mobile-site, assigning and programming at least one transceiver from the plurality of transceivers to monitor at least one first channel of at least one fixed-site; receiving a message on the at least one first channel identifying a call for one or more subscriber units operable in the mobile-site; and determining, from the message, whether the call is of interest to any subscriber units at the mobile site. Responsive to determining that the call is of interest, the method further comprises assigning a first particular transceiver out of the plurality of transceivers to provide a second channel for the call at the mobile-site and informing the one or more subscriber units affected by the call of the assigned second channel; assigning a second particular transceiver out of the plurality of transceivers to provide a link from the mobile site to the fixed-site for the call; and propagating the call on the assigned second channel to/from the subscriber units affected by the call.

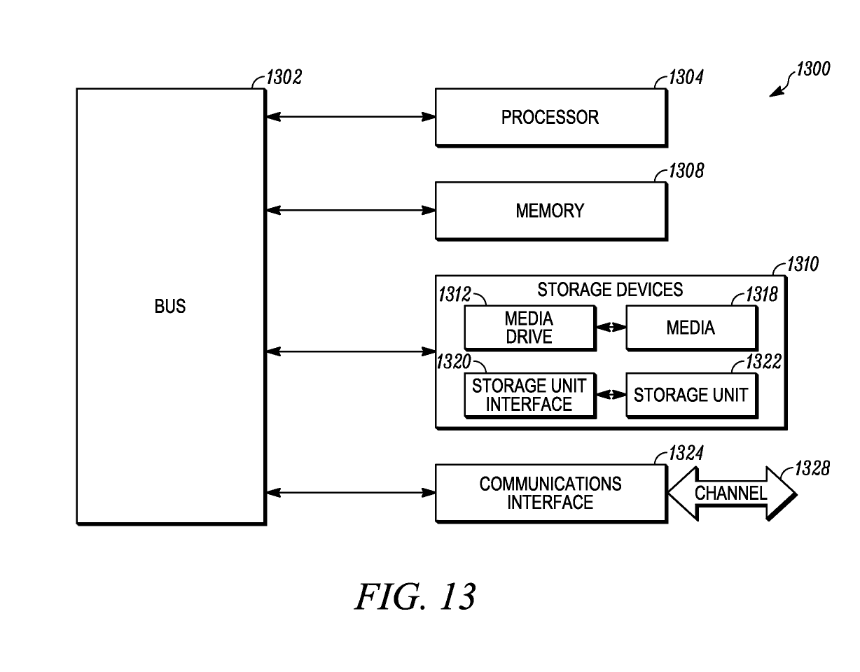

Referring now to FIG. 13, there is illustrated an example computing system 1300 that may be employed to implement controller functionality in embodiments of the invention. Computing system 1300 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1300 can include one or more processors, such as a signal processing module 243, 543, 743, 943 or control module 242, 542, 742, 942. Processor 1304 can be implemented using a general or special-purpose processing engine such as, for example, a microprocessor, microcontroller or other control logic. In this example, processor 1304 is connected to a bus 1302 or other communications medium.

Computing system 1300 can also include a main memory 1308, such as random access memory (RAM) or other dynamic memory, for storing information and instructions to be executed by processor 1304. Main memory 1308 also may be used for storing temporary variables or other intermediate information during execution of instructions to be executed by processor 1304. Computing system 1300 may likewise include a read only memory (ROM) or other static storage device coupled to bus 1302 for storing static information and instructions for processor 1304.

The computing system 1300 may also include information storage system 1310, which may include, for example, a media drive 1312 and a removable storage interface 1320. The media drive 1312 may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media 1318 may include, for example, a hard disk, floppy disk, magnetic tape, optical disk, CD or DVD, or other fixed or removable medium that is read by and written to by media drive 1312. As these examples illustrate, the storage media 1318 may include a computer-readable storage medium having particular computer software or data stored therein.

In alternative embodiments, information storage system 1310 may include other similar components for allowing computer programs or other instructions or data to be loaded into computing system 1300. Such components may include, for example, a removable storage unit 1322 and an interface 1320, such as a program cartridge and cartridge interface, a removable memory (for example, a flash memory or other removable memory module) and memory slot, and other removable storage units 1322 and interfaces 1320 that allow software and data to be transferred from the removable storage unit 1318 to computing system 1300.

Computing system 1300 can also include a communications interface 1324. Communications interface 1324 can be used to allow software and data to be transferred between computing system 1300) and external devices. Examples of communications interface 1324 can include a modem, a network interface (such as an Ethernet or other NIC card), a communications port (such as for example, a universal serial bus (USB) port), a PCMCIA slot and card, etc. Software and data transferred via communications interface 1324 are in the form of signals which can be electronic, electromagnetic, and optical or other signals capable of being received by communications interface 1324. These signals are provided to communications interface 1324 via a channel 1328. This channel 1328 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms ‘computer program product’, ‘computer-readable medium’ and the like may be used generally to refer to media such as, for example, memory 1308, storage device 1318, or storage unit 1322. These and other forms of computer-readable media may store one or more instructions for use by processor 1304, to cause the processor to perform specified operations. Such instructions, generally referred to as ‘computer program code’ (which may be grouped in the form of computer programs or other groupings), when executed, enable the computing system 1300 to perform functions of embodiments of the present invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 1300 using, for example, removable storage drive 1322, drive 1312 or communications interface 1324. The control logic (in this example, software instructions or computer program code), when executed by the processor 1304, causes the processor 1304 to perform the functions of the invention as described herein, including one or more of the steps set forth in the flow charts of FIGS. 4, 6, 8, and 11 and/or one or more of the communications steps set forth with respect to FIGS. 2, 3, 5, 7, and 9.

Hence, in accordance with example embodiments of the invention, the controller is configured with (or a memory in the controller includes) programming instructions, that when executed by, say the signal processing module 243, 543, 743, 943 or the control module 242, 542, 742, 942 in the controller, executes one or more of the controller steps set forth above, including monitoring and dynamically extending both conventional and trunked radio systems via a dynamically created local conventional or trunked mobile site.

Thus, in accordance with examples embodiments, a controller for supporting mobile-site communication with a fixed-site in a wireless communication system is described, wherein the mobile-site comprises a plurality of transceivers. The controller comprises: at least one wireless transceiver interface; and at least one control module operably coupled to the at least one wireless transceiver interface and arranged to: assign and program, via the wireless transceiver interface, at least one wireless transceiver from the plurality of transceivers to monitor at least one first channel on the fixed-site; receive a message on the at least one first channel identifying a call for one or more subscriber units operable in the mobile-site; determine, from the message, whether the call is of interest to any subscriber units at the mobile site. Responsive to determining that the call is of interest, the at least one control module: assigns a first particular transceiver out of the plurality of transceivers to provide a second channel for the call on the mobile-site and informs the one or more subscriber units affected by the call of the assigned second channel; assigns a second particular transceiver out of the plurality of transceivers to provide a link from the mobile site to the fixed-site for the call; and propagate the call on the assigned second channel to/from the subscriber units affected by the call.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of supporting mobile-site communication with a fixed-site in a wireless communication system wherein the mobile-site comprises a controller and a plurality of transceivers, the method comprising, at a mobile-site:
assigning and programming at least one transceiver from the plurality of transceivers to monitor at least one first channel of at least one fixed-site;
receiving a message on the at least one first channel identifying a call for one or more subscriber units operable in the mobile-site;
determining, from the message, whether the call is of interest to any subscriber units at the mobile site and, responsive to determining that the call is of interest:
assigning a first particular transceiver out of the plurality of transceivers to provide a second channel for the call at the mobile-site and informing the one or more subscriber units affected by the call of the assigned second channel;
assigning a second particular transceiver out of the plurality of transceivers to provide a link from the mobile site to the fixed-site for the call; and
propagating the call on the assigned second channel to/from the subscriber units affected by the call.

2. The method of claim 1 wherein the mobile-site and the at least one fixed-site support at least one from a group comprising: conventional mode of communication, and trunked mode of communication.

3. The method of claim 1 wherein receiving the message on the at least one first channel identifying a call for one or more subscriber units operable in the mobile-site comprises at least one from a group comprising: receiving a call request, affiliation or de-affiliation message.

4. The method of claim 3 further comprising determining whether at least one channel is available in response to receiving the message and if it is determined that no channel is available, pre-empting an existing lower priority call.

5. The method of claim 3 wherein the call request is an emergency call request received from either the at least one fixed-site or the mobile-site, wherein the method further comprises at least one from a group comprising assigning the at least one transceiver in the mobile-site to link to the at least one fixed-site.

6. The method of claim 3 further comprising prioritizing calls across available mobile-site resources based at least partly on the call request.

7. The method of claim 6 wherein the call request is an emergency call request received from either the at least one fixed-site or the mobile-site, wherein the method further comprises pre-empting a normal call to make at least one channel resource available.

8. The method of claim 1 further comprising determining that the call is of interest for one or more subscriber units operable in the mobile-site based at least partly on the message identifying at least one from a group comprising: call priority, a talk group identifier, a network access code, a call type, a channel number from which a call is propagated.

9. The method of claim 1 wherein assigning and programming the at least one transceiver to monitor at least one first channel on the at least one fixed-site comprises selecting at least one transceiver and configuring the at least one transceiver's transmit and receive frequencies accordingly.

10. The method of claim 1 further comprising determining those calls that require propagating in the mobile-site and propagating the call on the assigned second channel to/from the subscriber units affected by the call in response thereto

11. The method of claim 1 further comprising assigning at least one transceiver to monitor at least one channel comprises determining whether the fixed-site is a trunked fixed-site or a conventional fixed-site, and in response thereto, performing at least one from a group comprising:
monitoring a control channel of at least one trunked fixed-site; and
scanning one or more conventional channels of at least one conventional fixed-site.

12. The method of claim 11, further comprising assigning at least one transceiver to monitor at least one channel comprises both assigning at least one transceiver to monitor a control channel of at least one trunked fixed-site and assigning another transceiver to scan one or more conventional channels of at least one conventional fixed-site.

13. The method of claim 11 further comprising stopping an existing emergency call or a normal call to free up resources in order to perform scanning of the plurality of channels on the conventional fixed-site.

14. The method of claim 1 further comprising providing a subscriber unit in the mobile-site with information identifying a source of a call.

15. The method of claim 1 wherein the at least one fixed-site comprises at least one from a group comprising: a public or private mobile radio, Private Broadband, long-term evolution (LTE), global system for mobile communication (GSM), a third generation (3G) system, a fourth generation system.

16. A non-transitory computer program product comprising executable program code supporting mobile-site communication with a fixed-site in a wireless communication system, the executable program code operable for, when executed at a controller in the mobile-site, performing the method of claim 1.

17. A controller for supporting mobile-site communication with a fixed-site in a wireless communication system wherein the mobile-site comprises a plurality of transceivers, wherein the controller comprises:
at least one wireless transceiver interface; and
at least one control module operably coupled to the at least one wireless transceiver interface and arranged to:
assign and program, via the wireless transceiver interface, at least one wireless transceiver from the plurality of transceivers to monitor at least one first channel on the fixed-site;
receive a message on the at least one first channel identifying a call for one or more subscriber units operable in the mobile-site:
determine, from the message, whether the call is of interest to any subscriber units at the mobile site and, responsive to determining that the call is of interest:
assign a first particular transceiver out of the plurality of transceivers to provide a second channel for the call on the mobile-site to inform the one or more subscriber units affected by the call of the assigned second channel;
assign a second particular transceiver out of the plurality of transceivers to provide a link from the mobile site to the fixed-site for the call; and
propagate the call on the assigned second channel to/from the subscriber units affected by the call.

17. The controller of claim 16, the controller further configured to assign at least one transceiver to monitor at least one channel by determining whether the fixed-site is a trunked fixed-site or a conventional fixed-site, and in response thereto, performing at least one from a group comprising:
monitoring, via the assigned at least one wireless transceiver, a control channel of at least one trunked fixed-site; and
scanning, via the assigned at least one wireless transceiver, one or more conventional channels of at least one conventional fixed-site.

18. The controller of claim 17, the controller further configured to assign at least one wireless transceiver to monitor the control channel of the at least one trunked fixed-site and at least another transceiver to scan the one or more conventional channels of the at least one conventional fixed-site.

19. An integrated circuit for a controller for supporting mobile-site communication with a fixed-site in a wireless communication system wherein the mobile-site comprises a plurality of transceivers, wherein the integrated circuit comprises:
at least one control module operably coupled to the at least one wireless transceiver interface and arranged to:
assign and program at least one wireless transceiver from the plurality of transceivers to monitor at least one first channel on the fixed-site;
receive a message on the at least one first channel identifying a call for one or more subscriber units operable in the mobile-site;
assign a second channel for the call on the mobile-site and informing the one or more subscriber units affected by the call of the assigned second channel of the call; and
propagate the call on the assigned second channel to/from the subscriber units affected by the call.

20. A method of supporting mobile-site communication with a fixed-site in a wireless communication system wherein the mobile-site comprises a controller and a plurality of transceivers, the method comprising, at a mobile-site:
receiving a call request from at least one subscriber unit on at least one channel of the mobile-site;
determining from the call request that the call is to be routed to the fixed-site;
assigning and programming a transceiver from the plurality of transceivers in the mobile-site to request a channel on the control channel of the fixed-site;
receiving an assignment of a second channel for propagating the call on the mobile-site; and
propagating the call on the assigned second channel between the fixed-site and the one or more subscriber units.
